(19) United States
(12) Patent Application Publication
(10) Pub. No.: US 2006/0213069 A1
(43) Pub. Date: Sep. 28, 2006

(54) Laser protractor

(76) Inventor: Johnny Martin, Chula Vista, CA (US)

Correspondence Address: JAMES RAY & ASSOCIATES, 2640 PITCAIRN ROAD, MONROEVILLE, PA, 15146, US

(21) Appl. No.: 11/388,543

(22) Filed: Mar. 24, 2006

Related U.S. Application Data
(60) Provisional application No. 60/665,642, filed on Mar. 25, 2005.

(51) Int. Cl. G01C 15/00

(52) U.S. Cl. 33/286

(57) ABSTRACT

A protractor for measuring and constructing angles includes a body having a base member and an arcuate member connecting opposed ends of the base member. A bottom surface of the base member and a bottom surface of the arcuate member are disposed in a substantially identical plane. A degree scale is engageable with a predetermined portion of the arcuate member and an elongated arm has a first end rotatably attached to the base member and has a second end disposed in close proximity to the degree scale. A laser is attached to the second end of the elongated arm and is capable of generating a light beam.

### CROSS-REFERENCE TO RELATED APPLICATIONS

This application is related to and claims priority from Provisional Patent Application Ser. No. 60/665,642 filed Mar. 25, 2005.

### FIELD OF THE INVENTION

The present invention relates, in general, to measuring and marking devices and, more particularly, this invention relates to protractors having a laser device for measuring and constructing angles.

### BACKGROUND OF THE INVENTION

As is generally well known, devices are available to assist professionals and homeowners alike in easily and simply finding or constructing a straight line. However, a process of measuring or constructing angles, particularly over large surfaces or distances, generally requires several iterations and use of several tools. Such conditions increase the effort required to measure or construct angles, often frustrating the person performing this task. The condition may further result in a less than desirable quality of the completed effort.

Attempts have been made to alleviate the difficulties in measuring and constructing angles over large surfaces or distances. U.S. Pat. No. 6,453,568 to Hymer discloses a laser protractor comprising two laser pointers fixed in a body to point exactly 90 degrees apart in the same plane and a third laser pointer mounted on a movable arm rotatable about an axis perpendicular to the intersection of the first two laser pointers and is further rotatable within a 90 degree segment. The laser protractor includes leveling bubbles and degree scales mounted on the body, permitting the protractor to be accurately positioned with both fixed lasers in a horizontal plane, in a vertical plane or in any other plane as required.

While such laser protractor is advantageous to measure and construct angles, employment of three lasers and associated batteries increases manufacturing and maintenance costs of such device. Furthermore, the arrangement employed for temporarily securing such laser beam is associated with higher manufacturing costs as well and prevents angle construction and measurement over a 360 degrees rotational range.

### SUMMARY OF THE INVENTION

According to a first embodiment, the invention provides a protractor for measuring and constructing angles. The protractor includes a body having a base member and an arcuate member connecting opposed ends of the base member. A bottom surface of the base member and a bottom surface of the arcuate member are disposed in a substantially identical plane. A degree scale is engageable with a predetermined portion of the arcuate member. An elongated arm has a first end rotateably attached to the base member and has a second end disposed in close proximity to the degree scale. A laser is attached to the second end of the elongated arm and is capable of generating a light beam.

According to a second embodiment of the invention, there is provided a protractor for measuring and constructing angles which includes a body and an arm rotateably affixed to the body. There is a first direction which is fixed relative to the body and which is defined by a first coherent light beam and a second direction fixed relative to the body and which is defined by a second coherent light beam. The first and second fixed directions form first and second axes, respectively, which are positioned relative to the body to perpendicularly intersect. A third direction is specified relative to the arm and is defined by a third coherent light beam and a third axis passing through the intersect of the first and second axes. The third axis forms the axis of rotation of the arm relative to the body. At least one laser is attached to the protractor and is capable of producing the coherent light beams. A plunger and a spring mounted in the arm and a plurality of one of cavities and grooves disposed within the body and aligned in a predetermined pattern are provided for securing the coherent light beam produced by the third laser in an angular position in a removable manner. The spring biases the plunger outwardly from a bottom surface of the arm for engagement with a respective one of the plurality of one of such cavities and grooves.

### OBJECTS OF THE INVENTION

It is, therefore, one of the primary objects of the present invention to provide a laser protractor for constructing and measuring angles.

Another object of the present invention is to provide a laser protractor for constructing and measuring angles over large surfaces and distances.

Yet another object of the present invention is to provide a laser protractor for constructing and measuring angles which employs simple means for securing a generated light beam in a preselected position in a removable manner.

A further object of the present invention is to provide a laser protractor for constructing and measuring angles which is simple to use.

Yet a further object of the present invention is to provide a laser protractor for constructing and measuring angles which is economical to manufacture.

An additional object of the present invention is to provide a laser protractor for constructing and measuring angles over a rotational range of 360 degrees.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a plan view of a laser protractor of the present invention showing a body member according to one embodiment of the invention;

FIG. 2 is a cross-sectional elevation view of the laser protractor taken along lines 2-2 of FIG. 1;

FIG. 3 is a partial elevation view of the laser protractor of FIG. 1 illustrating a means for attaching such laser protractor to a rigid surface; and

FIG. 4 is a plan view of the laser protractor of the present invention showing a body member according to another embodiment of the invention;

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

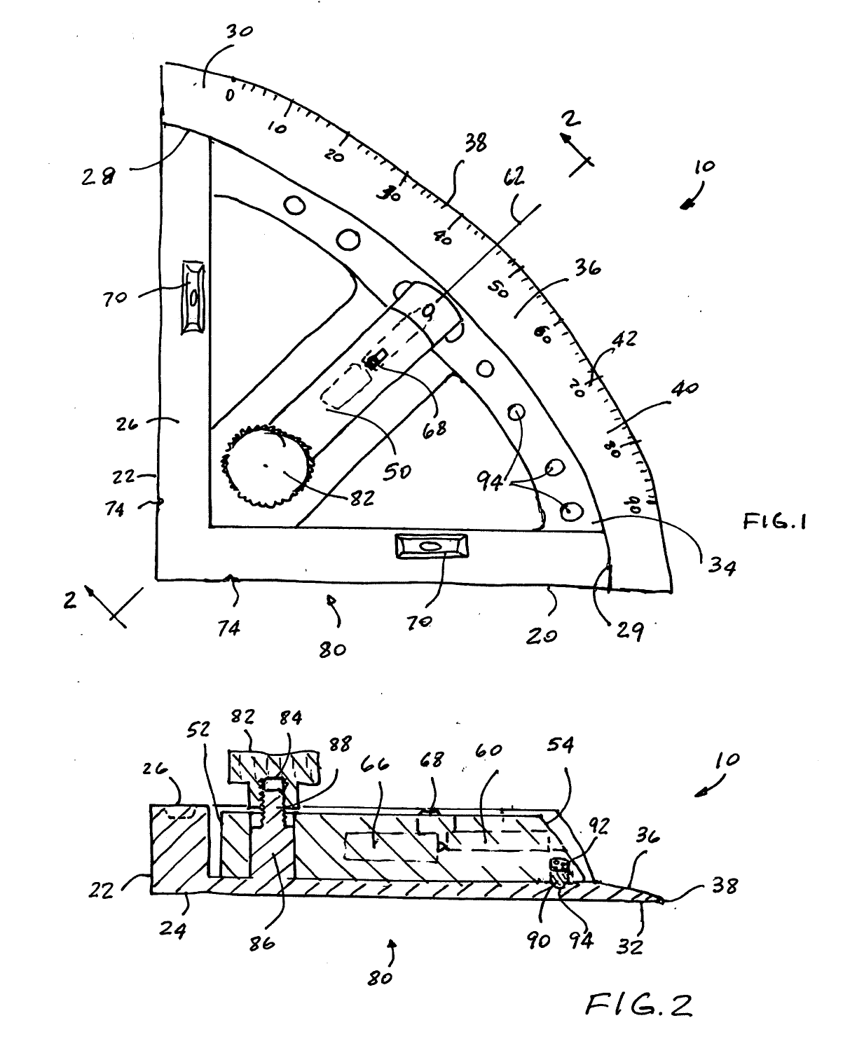

Reference is now made, to FIGS. 1-4, wherein there is shown a laser protractor, generally designated 10, for measuring and constructing angles. Such laser protractor 10 comprises a body 20, preferably of a unitary construction, including a base member 22, which has a bottom surface 24 and an opposed top surface 26. The body 20 further includes an arcuate member 30 having a bottom surface 32 and an opposed top surface 34. Such arcuate member 30 connects opposed ends 28 and 29 of the base member 22. Preferably, the bottom surface 24 of the base member 22 and the bottom surface 32 of the arcuate member 30 are disposed in a substantially identical plane. Furthermore, for the reason to be explained below, at least a portion of the top surface 26 of the base member 22 is elevated above the top surface 32 of the arcuate member 30.

A scale means 40 is provided in engagement with a predetermined portion of the arcuate member 30. The scale means 40 includes a plurality of graduated markings 42 which are formed in such predetermined portion of the arcuate member 30 and are spaced from each other at a predetermined angle. Each of such plurality of markings 42 may be one of recessed and raised. Preferably, such arcuate member 30 has a predetermined tapered portion 36 which is tapered, at a predetermined angle, towards the bottom surface 32 of the arcuate member 30 and outwardly from the base member 22. Advantageously, the plurality of markings 42 will be disposed on such tapered portion 36 and will be further disposed adjacent an outer edge 38 of such arcuate member 30. Alternatively, a decal (not shown) containing such markings 42 may be applied to the tapered portion 36. The plurality of markings 42 and the tapered portion 36 are provided with contrasting colors for ease of viewing such plurality of markings 42.

The protractor 10 further includes an elongated arm 50 which has a first end 52 rotateably attached to the base member 22 and a second end 54 disposed in close proximity to the scale means 40. A laser 60, for generating a light beam 62 is attached to the second end 54 of the elongated arm 50. Such laser 60 is disclosed, for example, in U.S. Pat. No. 6,453,568 to Hymer, the teachings of which are incorporated into this application by reference thereto. As is known, such laser 60 is mounted internal to the second end 54 of the elongated arm 50 and is operable by way of at least one battery 66 further disposed internal to the elongated arm 50. Preferably, a simple switch 68 is provided for selectively operating the laser 60 from the at least one battery 66.

There is a means 70 engageable with the base member 22 for leveling the protractor 10 in at least one plane. Preferably, such leveling means 70 is a pair of glass bubble levels 70, each disposed in a predetermined location of the base member 22 for leveling the protractor 10 in one plane. The top of each glass bubble level 70 is one of essentially flush with and recessed below the top surface 26 of the base member 22. It is presently preferred that one glass bubble level 70 is mounted to level the protractor 10 in a first plane and another glass bubble level 70 is mounted to level the protractor 10 in a second plane which is substantially perpendicular to such first plane.

A pair of lines 74, each formed in the base member 22 perpendicular to and at least partially extending intermediate the bottom surface 24 and the top surface 26, are provided for aligning the protractor 10 in at least one direction. Furthermore, each marking 74 is aligned with a predetermined angular position of the scale means 40.

The protractor 10 further includes a means, generally designated 80, which is at least engageable with the elongated arm 50 for releasably securing it and the light beam 62 generated by the laser 60 in a preselected angular position.

In the presently preferred embodiment of the invention, such securing means 80 includes a knurled nut 82 provided with a threaded aperture 84 for engaging a threaded stem 88 of a pivot member 86 which is attached or integral to the base member 22 for enabling rotation of the elongated arm 50. Alternatively, such pivot member 86 and its threaded stem 88 may be integral to such knurled nut 82, wherein the base member 22 will be provided with a complimentary threaded aperture (not shown).

Alternatively to or in combination with the knurled nut 82, such securing means 80 includes a plunger 90 and a spring 92, both mounted in the elongated arm 50. There is a plurality of cavities or grooves 94 disposed within the arcuate member 30. Each cavity or groove 94 is aligned with a preselected angular position of the scale means 40. It will be appreciated that when elongated arm 50 is moved into a position above such cavity or groove 94, the spring 92 biases the plunger 90 outwardly from a bottom surface of the elongated arm 50 thus causing the plunger 90 to engage such cavity or groove 94 and enabling the light beam 62 to be secured in a preselected angular position in a removable manner. The rate of spring 92 is preselected to enable the plunger 90 to disengage such cavity or groove 94 when the elongated arm 50 is moved by way of manual force applied thereto. It will be understood that the plunger 90 may be a spherical ball 90.

According to one embodiment of the invention, best shown in FIG. 1, the base member 22 is formed in an L-shape configuration. In such embodiment, the pair of markings 74 form a pair of axis perpendicular to each other and, accordingly, the scale means 40 is formed as a 90 degree quarter scale.

According to another embodiment, best shown in FIG. 4, the base member 96 has an elongated shape and the scale means 40 is at least formed as a 180 degree half scale. Those skilled in the art will readily understand that protractors 10 having a 90 degree scale, 180 degree scale or 360 degree scale are most commonly used for constructing and measuring angles.

Material of each of the unitary member 20 and the elongated arm 50 is one of metal, wood, thermoplastic and various combinations thereof. The presently preferred material is thermoplastic thus providing for simple and economical manufacture of such protractor 10.

In use, to construct a preselected angle, the base member 22 is directionally aligned by way of markings 74 and is further aligned in vertical and horizontal planes by way of glass bubble levels 70. The laser 60 is activated to generate the light beam 62. The elongated arm 50 is then rotated along the scale means 40 to an angular position wherein the light beam 62 is aligned with such preselected angle of the scale means 40 and the knurled nut 82 is manually tightened to secure the light beam 62 in such angular position. When the angular position corresponds with a location of one of such plurality of cavities or grooves 94, only the plunger 90 may be used to secure the light beam 62 in such angular position.

When such protractor 10 includes a 90 degree quarter scale or a 180 degree half scale, the top surface 26 of the base member 22, which is elevated above the top surface 32 of the arcuate member 30, limits the rotation of the elongated arm 50 within the boundaries of such body 20.

The procedure to measure an angle is the same as described above, except that such angle will be determined when a laser beam 62 is aligned with one of a plurality of markings 42 associated with such angle.

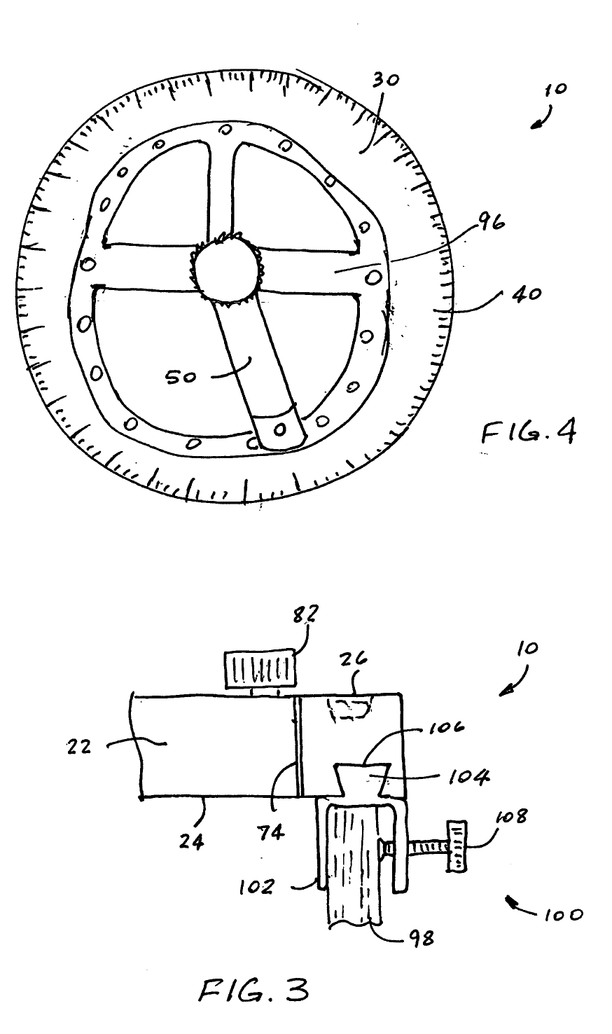

In applications, requiring attachment of the protractor 10 to a rigid structure 98, such protractor 10 is adapted with a clamp means, generally designated 100, which is removably engageable with the body 20. Now in reference to FIG. 3, such clamp means 100 includes a flanged bracket 102 having a tail 104 which abutingly engages a complimentary groove 106 formed in the base member 22. At least one well known thumb screw 108 is provided for securing such flanged bracket 102 onto the structure 98. Such embodiment will enable the user of the protractor 10 to attach it to such rigid structure 98 while performing other tasks and measurements over a large surface or distance and remove the bracket 102 for using protractor 10 on a planar surface.

By way of example, the structure 98 is shown in FIG. 3 as a wooden post 98 which may be found in various construction and landscaping applications. It will be apparent to those skilled in the art that the bracket 102 may be configured to fit other rigid structures.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A protractor comprising:
(a) a body having a base member and an arcuate member connecting opposed ends of said base member, wherein a bottom surface of said base member and a bottom surface of said arcuate member are disposed in a substantially identical plane;
(b) a scale means engageable with a predetermined portion of said arcuate member;
(c) an elongated arm having a first end rotateably attached to said base member and having a second end disposed in a close proximity to said scale means; and
(d) a laser attached to said second end of said elongated arm, said laser capable of generating a light beam.

2. The protractor, according to claim 1, wherein at least a portion of a top surface of said base member is elevated above a top surface of said arcuate member for limiting rotation of said elongated arm.

3. The protractor, according to claim 1, wherein said arcuate member has a predetermined tapered portion which is tapered, at a predetermined angle, towards said bottom surface of said arcuate member and outwardly from said base member.

4. The protractor, according to claim 1, wherein said scale means is disposed on said tapered portion of said arcuate member.

5. The protractor, according to claims 1, wherein said protractor includes means engageable with said base member for leveling said protractor in at least one plane.

6. The protractor, according to claim 5, wherein said leveling means includes a pair of glass bubble levels, each disposed in a predetermined location of said base member for leveling said protractor in one plane.

7. The protractor, according to claim 6, wherein a top of each glass bubble level is one of essentially flush with and recessed below a top surface of said base member.

8. The protractor, according to claim 1, wherein said protractor further includes an alignment means disposed within said base member.

9. The protractor, according to claim 8, wherein said alignment means includes a pair of markings each aligned with a predetermined angular position of said scale means and at least partially extending intermediate said bottom surface and a top surface of said base member.

10. The protractor, according to claim 1, wherein said laser is mounted internal to said elongated arm.

11. The protractor, according to claim 1, wherein said laser is operable by way of at least one battery disposed internal to said elongated arm.

12. The protractor, according to claim 1, wherein said protractor further includes means at least engageable with said elongated arm for securing it and said light beam generated by said laser in a preselected angular position.

13. The protractor, according to claim 12, wherein said securing means includes a knurled nut threadedly engaging a threaded stem of a pivot member being one of attached and integral to said base member, said pivot member enabling rotation of said elongated arm.

14. The protractor, according to claim 12, wherein said securing means includes a plunger and a spring mounted in said elongated arm and a plurality of one of cavities and grooves disposed within said arcuate member each aligned with a predetermined angular position of said scale means, wherein said spring biases said plunger outwardly from a bottom surface of said elongated arm for engagement with a respective one of said plurality of one of cavities and grooves and for releasably securing said light beam in said preselected angular position.

15. The protractor, according to claim 1, wherein said protractor further includes a switch means for selectively operating said laser.

16. The protractor, according to claim 1, wherein said base member has an L-shape and said scale means is a 90 degree quarter scale.

17. The protractor, according to claim 1, wherein said base member has an elongated shape and said scale means is at least a 180 degree half scale.

18. A protractor comprising:
(a) a body;
(b) a first laser affixed to said body and capable of producing a coherent light beam in a first specified direction forming a first axis relative to said body;
(c) a second laser affixed to said body and capable of producing a coherent light beam in a second specified direction forming a second axis relative to said body, wherein said first specified direction of said first laser and said second specified direction of said second laser, each extended behind said first laser and said second laser, respectively, intersect perpendicularly;
(d) an arm rotateably affixed to said body, said arm rotatable about a third axis, said third axis passing through said perpendicular intersect and perpendicular to both said first specified direction of said first laser and said second specified direction of said second laser;
(e) a third laser affixed to said arm and capable of producing a coherent light beam in a specified direction relative to said arm, said specified direction of said third laser as extended behind said third laser perpendicularly intersecting said third axis;
(f) means engageable with said body for indicating said angular relationship of said light beam of said third laser relative to at least one of said light beams of said first and second lasers; and
(g) a securing means engageable with said arm and said body, said securing means includes a plunger and a spring mounted in said arm and a plurality of one of cavities and grooves disposed within said body each aligned with a predetermined angular position of said angular relationship means, wherein said spring biases said plunger outwardly from a bottom surface of said arm for engagement with a respective one of said plurality of one of cavities and grooves and for releasably securing said coherent light beam produced by said third laser in said preselected angular position.

19. The protractor, according to claim 18, wherein said protractor further includes means at least engageable with said arm for temporarily securing said arm in an angular position, said securing means are aligned with said third axis.

20. A protractor comprising:
(a) a body;
(b) an arm rotateably affixed to said body;
(c) a first direction fixed relative to said body and defined by a first coherent light beam;
(d) a second direction fixed relative to said body and defined by a second coherent light beam, said first and second fixed directions forming first and second axes, respectively, said first and second axes positioned relative to said body to perpendicularly intersect;
(e) a third direction specified relative to said arm and defined by a third coherent light beam and a third axis passing through said intersect of said first and second axes, said third axis forming said axis of rotation of said arm relative to said body;
(f) at least one laser on said protractor capable of producing said coherent light beams; and
(h) a securing means engageable with said arm and said body, said securing means includes a plunger and a spring mounted in said arm and a plurality of one of cavities and grooves disposed within said body and aligned in a predetermined pattern, wherein said spring biases said plunger outwardly from a bottom surface of said arm for engagement with a respective one of said plurality of one of cavities and grooves and for releasably securing said coherent light beam produced by said third laser in an angular position.
